(19) United States
(12) Patent Application Publication
(10) Pub. No.: US 2003/0020797 A1
(43) Pub. Date: Jan. 30, 2003

(54) Printer with photo stand and photo stand detachably attachable to printer

(75) Inventors: Toshihiro Takahashi, Nagoya-shi (JP); Satoru Hattori, Nagoya-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 10/023,803

(22) Filed: Dec. 21, 2001

(30) Foreign Application Priority Data
Jul. 30, 2001 (JP) 2001-228852

(51) Int. Cl. B41J 29/13

(52) U.S. Cl. 347/108

(57) ABSTRACT

A printer with a photo stand is constructed by which the photo stand is attached to the tape printer so as to cover a left side surface of a housing of the tape printer. In the printer with the photo stand, the tape printer is inclined with respect to an installed plane. With this structure, a photograph held in the photo stand is oriented toward a direction that a picture side of the photograph can be easily seen. A protrusion is provided to a lower surface of a cover of the tape printer, so that the printer with the photo stand can be prevented from falling in an inclined direction of the tape printer. The photo stand can be attached to the tape printer to form a single-piece unit, so that the printer with the photo stand saves space while displaying the photograph.

### BACKGROUND OF THE INVENTION

1. Field of Invention

The invention relates to a printer, and more particularly, to a printer to which a photo stand is detachably attached and a photo stand detachably attachable to the printer.

2. Description of Related Art

Conventionally, small and compact printers that have a tape wound therein and print indicia, such as characters and symbols, on the tape, have been used in offices, schools and the like. Labels on which characters and symbols are printed by the printer are adhered to office automation equipment, stationery and the like. The printers are small in size, so that the printers are used on desks in the offices and schools.

In the offices and schools, there are many cases where people display photographs of their families and friends on their desks. Accordingly, desktop work space becomes confined or a place for locating a keyboard, a mouse, documents or stationery is limited.

### SUMMARY OF THE INVENTION

The invention provides a printer with a photo stand in which a photograph can be displayed and that requires less space than a conventional printer and conventional photo stand and a photo stand detachably attachable to the printer.

According to one aspect of the invention, a printer with a photo stand that prints indicia on a recording medium includes an outer surface, a plurality of engagement portions formed on the outer surface, and a photo stand that is detachably attached to the engagement portions and can hold a photograph therein.

In the printer with the photo stand as structured above, the photo stand is detachably attached to the printer. When the printer and the photo stand are to be placed on a desk, it is unnecessary to place the printer and the photo stand separately. Accordingly, the desk space can be saved and effectively used.

### BRIEF DESCRIPTION OF THE DRAWINGS

An embodiment of the invention will be described in detail with reference to the following figures wherein:

FIG. 1 is a perspective view showing a printer with a photo stand;

FIG. 2 is a perspective view showing a tape printer;

FIG. 3 is a front view of the tape printer;

FIG. 4 is a rear view of the tape printer;

FIG. 5 is a bottom view of the tape printer;

FIG. 6 is a schematic block diagram showing an electric configuration of the tape printer;

FIG. 7 is a perspective view showing a photo stand;

FIG. 8 is a perspective view showing the photo stand;

FIG. 9 is a perspective view showing the photo stand that holds a photograph;

FIG. 10 is a front view showing the printer with the photo stand;

FIG. 11 is a sectional view taken along the line B-B of FIG. 10, looking in the direction of the appended arrows; and

FIG. 12 is a sectional view taken along the line A-A of the FIG. 1, looking in the direction of the appended arrows.

### DETAILED DESCRIPTION OF PREFERRED EMBODIMENTS

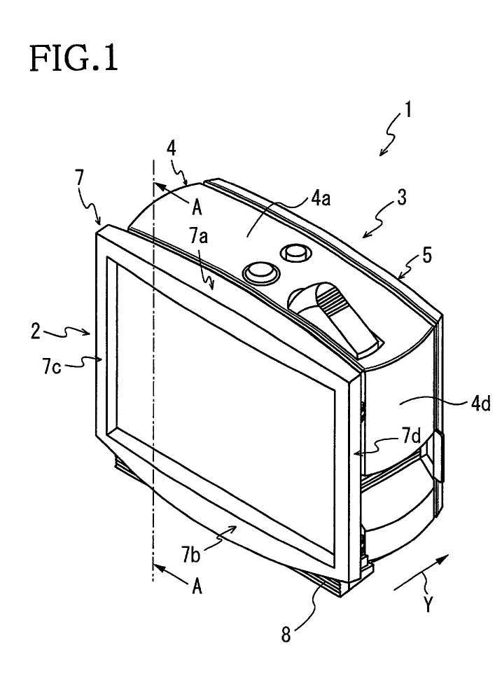

An embodiment of a printer with a photo stand of the invention will be described with reference to the accompanying drawings. In this embodiment, a printer with a photo stand that is structured such that a photo stand is attached to a tape printer is taken as an example. Referring to FIG. 1, an appearance of a printer with a photo stand 1 will be described.

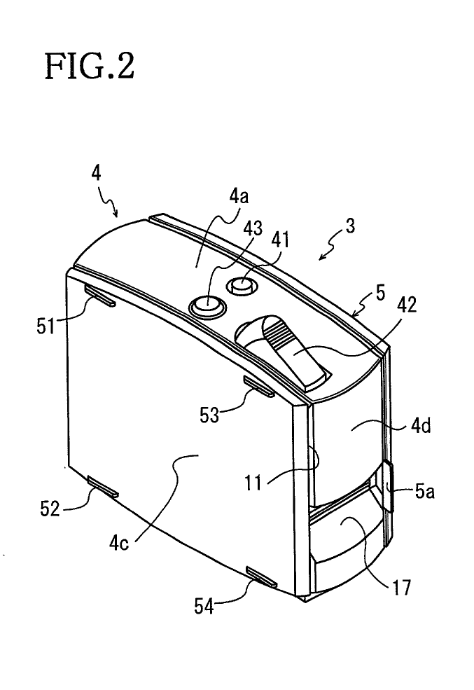

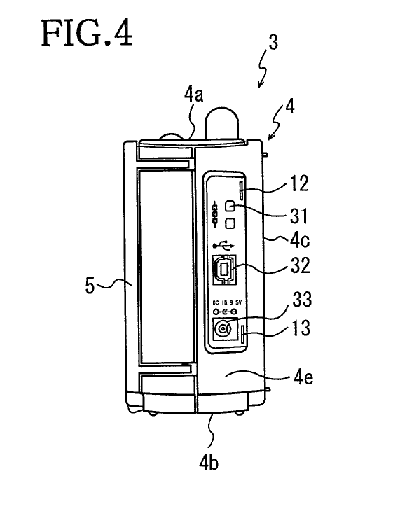

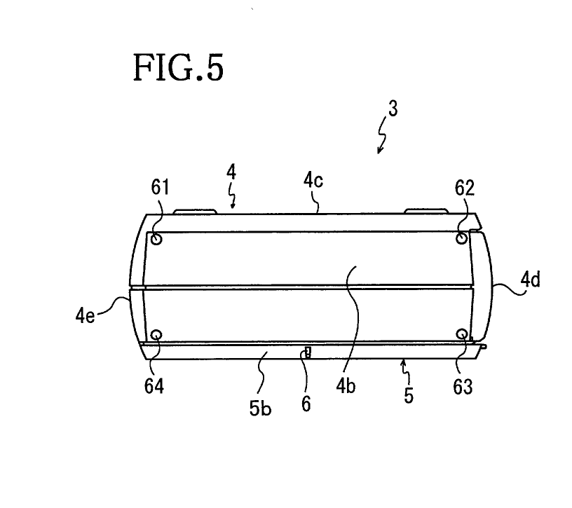

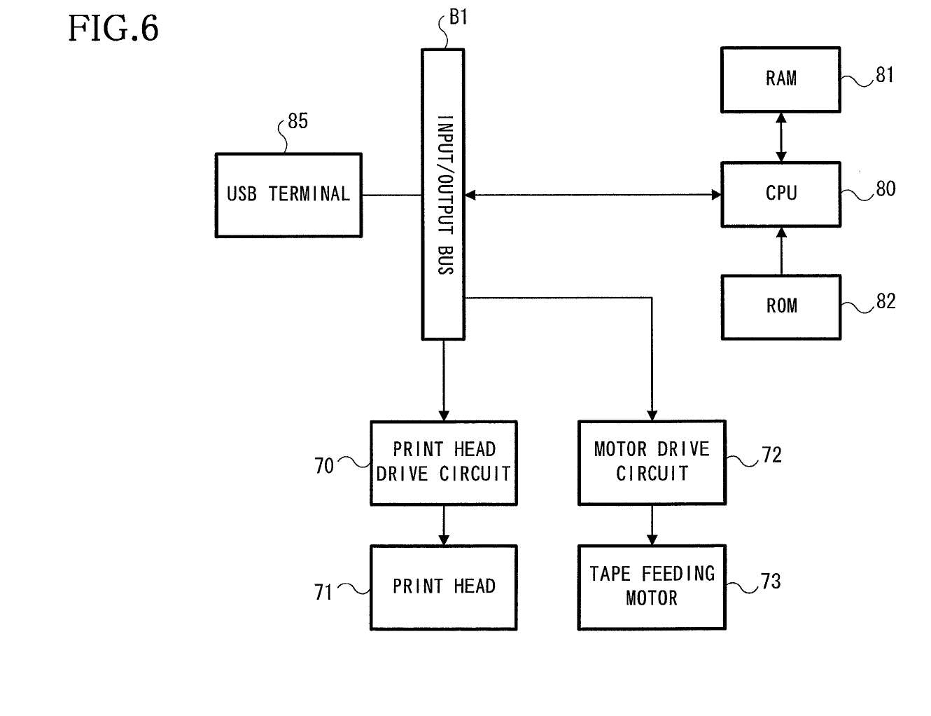

As shown in FIG. 1, the printer with a photo stand 1 is designed such that a photo stand 2 is detachably attached to a tape printer 3. The tape printer 3 includes a housing 4 that has five outer surfaces, an upper surface 4a, a lower surface 4b (FIG. 5), a left side surface 4c (FIG. 2), a front surface 4d and a rear surface 4e (FIG. 4). The housing 4 does not have a right side surface, so that the right side of the housing 4 is open (not shown). A cover 5 is rotatably provided to the right side of the housing 4. When the cover 5 is closed with respect to the right side of the housing 4, an open portion (not shown) in the right side of the housing 4 is covered with the cover 5. A motor drive circuit 72 (described later), a tape feeding motor 73 (FIG. 6) and the like are built into the housing 4. As described above, the tape printer 3 is structured by the cover 5 and the housing 4 accommodating the circuit 72, the mechanism and the like. The tape printer 3 can print indicia, such as characters and symbols, on a tape, which is wound in a tape cartridge (not shown). The tape cartridge is detachably attached to the inside of the tape printer 3 by opening the cover 5.

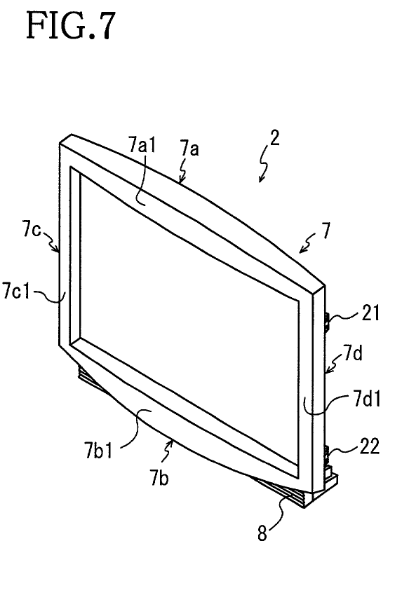

In the embodiment, the photo stand 2 is attached to tape printer 3 on the left side surface 4c. For convenience, in a frame 7 of the photo stand 2, frame portions provided on the sides of the upper surface 4a, the lower surface 4b, the front surface 4c and the rear surface 4c are referred to as an upper frame portion 7a, a lower frame portion 7b, a right side frame portion 7d and a left side frame portion 7c, respectively. As shown in FIG. 7, the photo stand 2 includes the substantially rectangular frame 7, which has the upper frame portion 7a, the lower frame portion 7b, the left side frame portion 7c and the right side frame portion 7d, and a bottom portion 8, which extends in a Y-axis direction in FIG. 1. The photo stand 2 can be attached to the tape printer 3 so as to cover the left side surface 4c of the tape printer 3. Photographs, small calendars or the like, can be placed in the photo stand 2 attached to the tape printer 3.

The housing 4 of the tape printer 3 is made of synthetic resin material. As shown in FIGS. 2 to 4, the tape printer 3 includes the housing 4 that has the upper surface 4a, the lower surface 4b, the left side surface 4c, the front surface 4d and the rear surface 4e. The housing 4 does not have the right side surface, so that the right side of the housing 4 is open (not shown). The cover 5 is rotatably provided to the right side of the housing 4. When the cover 5 is closed, an open portion (not shown) in the right side of the housing 4 is covered with the cover 5. A projection 5a is formed at a side edge of the cover 5 on the side of the front surface 4d. By pressing the projection 5a rightward in FIG. 2, the cover 5 can be easily opened. Each surface 4a to 4d has a pair of sides that are convexly curved outward, so that the surfaces 4a to 4d have a substantially rectangular shape. Each pair of the upper surface 4a and the lower surface 4b, the front surface 4d and the rear surface 4e, and the left side surface 4c and the cover 5, are symmetrical to each other. The motor drive circuit 72 (described later), the tape feeding motor 73 (FIG. 6) and the like are built into the housing 4. The tape printer 3 can print indicia, such as characters and symbols, on a tape, which is wound in a tape cartridge (not shown).

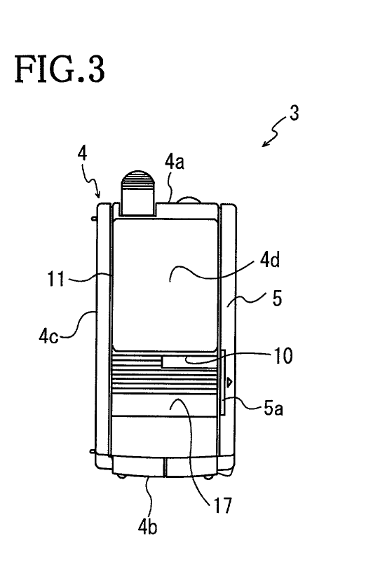

As shown in FIGS. 2 and 3, a recessed portion 17, which is recessed toward the inward of the tape printer 3, is formed at a lower portion of the front surface 4d of the housing 4. By inserting a finger into the recessed portion 17, it becomes easier to press rightwardly in FIG. 3 the projection 5a formed to the cover 5. Accordingly, the cover 5 can be easily opened. A tape outlet 10, which is a substantially rectangular through hole, is formed in at a upper portion in a back wall on the side of the cover 5 to discharge the tape (not shown) therefrom. A tape cutter for cutting the tape (not shown) is provided near the tape outlet 10 in the housing 4. The tape drawn from the tape outlet 10 is cut into an appropriate length by the tape cutter. An engagement groove 11 is provided on the left side of the front surface 4d, from the upper end to the lower end, and is substantially parallel with a longitudinal direction of the front surface 4d. The engagement groove 11 is engaged with engaging protrusions 21, 22 formed to the frame 7 of the photo stand 2 (see FIG. 7).

As shown in FIG. 4, a chain hook 31, a type B port 32, a receptacle 33 are aligned from top downward on the right half of the back surface 4e of the housing 4. An antitheft chain (not shown) is hooked on the chain hook 31. The type B port 32 is connected with a USB type B connector to make connection between the tape printer 3 and a personal computer using a USB cable. A power supply plug for supplying power to the tape printer 3 is inserted into the receptacle 33. Engagement grooves 12 and 13 are provided at the right upper and lower portions, respectively. Engaging protrusions 23, 24 (FIG. 7) formed to the frame 7 of the photo stand 2 are engaged with the engagement grooves 12, 13, respectively. The cover 5 is rotatably held on the side of the rear surface 4e to cover the open portion formed in the right side of the housing 4.

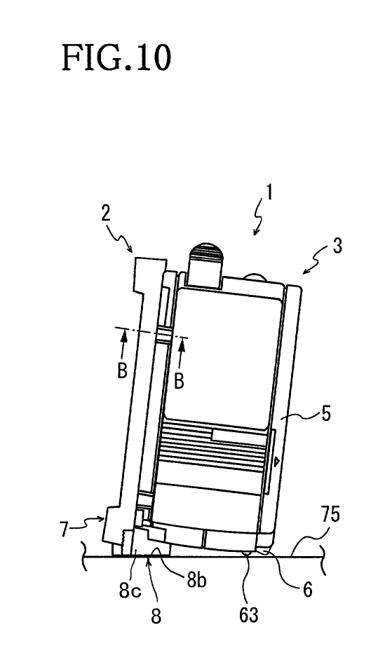

As shown in FIG. 5, four protruding feet 61 to 64 are provided on the lower surface 4b of the housing 4. The feet 61 to 64 are equally disposed at four corners of the lower surface 4b, when viewed from the lower surface 4b. The tape printer 3 can stand straight by the feet 61 to 64 with respect to an installed plane 75 of the tape printer 3 (FIG. 10). A protrusion 6 is provided at the middle of a lower surface 5b of the cover 5 provided on the right side of the housing 4. As shown in FIG. 10, when the photo stand 2 is attached to the left side surface 4c of the tape printer 3, the tape printer 3 inclined rightwardly with respect to the installed plane 75 can be prevented from falling toward the right in FIG. 10.

As shown in FIG. 2, a power button 41, a tape cut button 42 and an LED 43 are provided to the upper surface 4a of the housing 4. The power button 41 and the LED 43 are provided next to each other at the middle in the longitudinal direction of the upper surface 4a. The tape cut button 42 is provided on the upper surface 4a near the front side 4d. When the power button 41 is pressed while the power of the tape printer 3 is off, the tape printer 3 is turned on. When the power button 41 is pressed for a predetermined length of time or more while the power of the tape printer 3 is on, the tape (not shown) stored in the housing 4 is advanced to take up slack in the tape. When the tape cut button 42 is pressed, the tape that comes out from the tape outlet 10 is substantially perpendicularly cut into an appropriate length with respect to a tape feeding direction by the tape cutter (not shown) provided near the tape outlet 10.

Low protrusions 51 to 54, which are a rectangular parallelepiped, are provided on the left side surface 4c of the housing 4. The protrusions 51 and 53 are provided in positions at the same height. The protrusions 52 and 54 are provided in positions at the same height. The protrusions 51 to 54 are equally positioned at four corners of the left side surface 4c, when viewed from the left side surface 4c. A photograph 20 held by the photo stand 2 can be prevented from being vertically displaced by the protrusions 51 to 54 while the photo stand 2 is attached to the tape printer 3.

As shown in FIG. 6, the tape printer 3 includes a CPU 80 that controls the tape printer 3. The CPU 80 is connected with a RAM 81 that temporarily stores data and a ROM 82 that stores various kinks of control programs. The CPU 80 is also connected with a print head drive circuit 70, the motor drive circuit 72 and with a USB terminal 85 via an input/output bus B1. The print head drive circuit 70 and the motor drive circuit 72 are connected with a print head 71 and the tape feed motor 73, respectively. The tape printer 3 can be connected with a personal computer (not shown) by connecting the USB cable (not shown) to the USB terminal 85.

The photo stand 2 is made of synthetic resin material. As shown in FIGS. 7 to 9, the photo stand 2 includes the substantially rectangular frame 7 having the upper frame portion 7a, the lower frame portion 7b, the left side frame portion 7c and the right side frame portion 7d. The middle portion of the frame 7 is substantially rectangularly open. The upper frame portion 7a and the lower frame potion 7b are longer than the right and left side frame portions 7c, 7d. A surface 7a1 of the upper frame portion 7a is convexly curved such that a substantially middle portion of the surface 7a1 in the longitudinal direction is uplifted. A surface 7b1 of the lower frame portion 7b has the same shape. A surface 7c1 of the left side frame portion 7c and a surface 7d1 of the right side frame portion 7d are convexly curved such as substantially middle portions of the surfaces 7c1 and 7d1 are uplifted in accordance with the shape of the surfaces 7a1, 7b1 of the upper and lower frame portions 7a, 7b. The bottom portion 8 extends from the lower frame portion 7b of the frame 7, toward the rear side of the photo stand 2.

As shown in FIG. 10, in the bottom 8, a projected portion 8c inclinatorily projects toward the upper frame portion 7a from a lower surface 8b, forming an acute angle with the lower surface 8b. The lower surface 8b is parallel with the installed plane 75, so that the tape printer 3 to which the photo stand 2 is attached at the left side surface 4c is rightwardly inclined with respect to the installed plane 75 in FIG. 10.

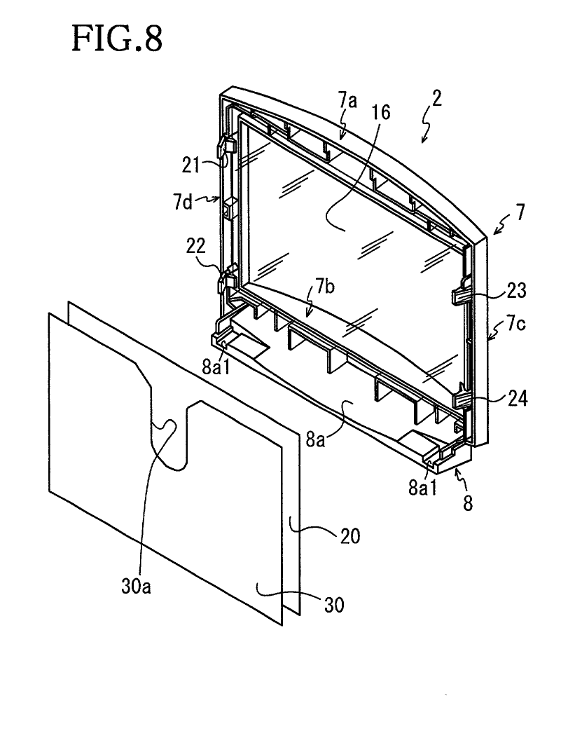

As shown in FIG. 8, right and left side end portions of an upper surface 8a of the bottom portion 8 is formed with a recessed portion 8a1. This prevents the feet 61, 62 provided on the lower surface 4b of the housing 4 of the tape printer 3 from interfering with the upper surface 8a of the bottom portion 8 when the photo stand 2 is attached to the tape printer 3.

The engaging protrusions 23, 24 protrude from the rear of the left side frame portion 7c of the frame 7. More particularly, the engaging protrusions 23 and 24 are disposed at the upper and lower portions of the left side frame portion 7c, respectively. The engaging protrusions 23 and 24 are mirror images of each other. The engaging protrusions 21 and 22 protrude from the read of the right side frame portion 7d. The engaging protrusions 21 and 22 are disposed at the upper and lower portions of the right side frame portion 7d, respectively. The engaging protrusions 21 and 23 are provided at the substantially same height. The engaging protrusion 22 is disposed near a lower end portion of the right side frame portion 7d.

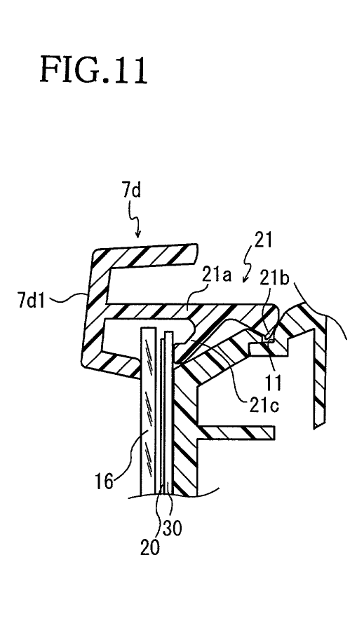

The engaging protrusions 21 to 24 have the substantially same shape. As shown in FIG. 11, for example, the engaging protrusion 21 includes a base portion 21a, a pawl portion 21b formed at an edge of the base portion 21a, and a photo holding portion 21c protruding from the base portion 21a. When the photo stand 2 is attached to the tape printer 3, the base portion 21a warps upward in FIG. 11 and the pawl portion 21b engages the engagement groove 11 provided in the front surface 4d of the housing 4 of the tape printer 3. The photograph 20 held by the photo stand 2 is urged from its rear by the photo holding portion 21c via a cardboard 30 provided behind the photograph 20. The engaging protrusions 22 to 24 have the same structure as the engaging protrusions 21. Accordingly, the photograph 20 is held in the photo stand 2 while urged from its rear by photo holding portions (not shown) provided to the engaging protrusions 22 to 24, in addition to the photo holding portion 21c. When the photo stand 2 is attached to the tape printer 3, base portions (not shown) provided to the engaging protrusions 22 to 24 also outwardly warp and pawl portions (not shown) formed to the respective base portions engage the respective engagement grooves 11 to 13 provided in the front and rear surfaces 4d, 4e of the housing 4 of the tape printer 3.

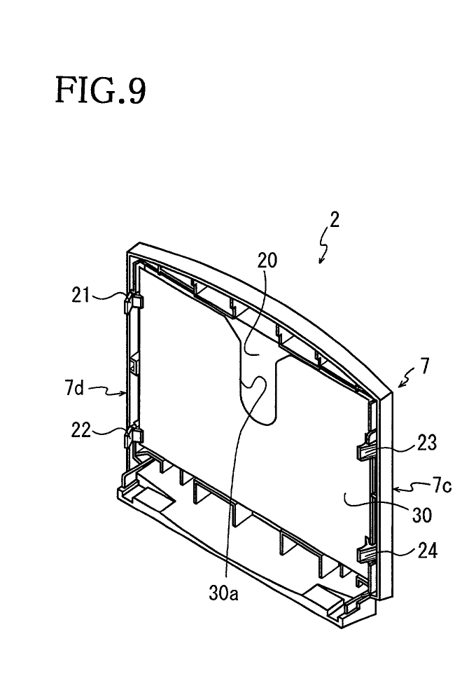

As shown in FIG. 8, the frame 7 of the photo stand 2 is provided with a substantially rectangular transparent panel 16. A portion of the transparent panel 16 is inserted between the right side frame portion 7d of the frame 7 and the engaging protrusion 21 provided at the rear of the right side frame portion 7d. Other portions of the transparent panel 16 are also inserted between the frame portions 7c, 7d and the engaging protrusions 22, 23, 24. The photo stand 2 holds the photograph 20 while sandwiching the photograph 20 by the cardboard 30 having the substantially same size as the transparent panel 16. The photograph 20 can be seen through the transparent panel 16 from a side opposite to the cardboard 30. The cardboard 30 has a substantially rectangular shape. A U-shaped cutaway portion 30a is formed in the cardboard 30 by which the cardboard 30 is partially cut away from an upper edge at a substantially middle portion in the longitudinal direction. As shown in FIGS. 9 and 11, the photograph 20 is inserted between the frame portions 7c, 7d, and the engaging protrusions 21 to 24. The cardboard 30 is also inserted therebetween and behind the photograph 20 (the right of the photograph 20 in FIG. 11). By doing so, the photograph 20 can be held in the photo stand 2 while seen from a picture side through the transparent panel 16.

In the bottom portion 8, the projected portion 8c inclinatorily projects toward the upper frame portion 7a from the lower surface 8b, forming an acute angle with the lower surface 8b. Therefore, when the photo stand 2 is attached to the tape printer 3, the tape printer 3 is inclined rightward in FIG. 10 with respect to the installed plane 75. In this state, the bottom portion 8 of the photo stand 2 becomes a bottom portion of the printer with the photo stand 1 constructed by the photo stand 2 and the tape printer 3. For example, when the photo stand 2 is used separately from the tape printer 3 to display the photograph 20 or the like, the frame 7 is inclined backward with respect to an installed plane on which the photo stand 2 is placed, that is, the bottom portion 8. Accordingly, the photograph 20 inserted in the photo stand 2 is oriented toward a direction that the picture side of the photograph 20 can be easily seen. As shown in FIG. 9, the cardboard 30, which is provided behind of the photograph 20, is formed with the cutaway portion 30a at its upper portion. Therefore, the photograph 20 can be upwardly pulled out of the photo stand 2 via the cutaway portion 30a using a finger, without removing the transparent panel 16 and the cardboard 30.

As shown in FIGS. 1, and 10 to 12, the printer with the photo stand 1 is structured such that the photo stand 2 is attached to the left side surface 4c of the housing 4 of the tape printer 3. The photo stand 2 is attached to the tape printer 3 as described below. First, the engaging protrusions 23, 24 (FIG. 8) provided to the left side frame portion 7c of the frame 7 of the photo stand 2 are engaged with the engagement grooves 12, 13 (FIG. 4), respectively, provided to the rear surface 4e of the tape printer 3. Then, the engaging protrusions 21, 22 (FIG. 7) provided to the right side frame portion 7d of the frame 7 of the photo stand 2 are engaged with the engagement groove 11 (FIG. 3) provided to the front surface 4d of the tape printer 3. Thus, the left side surface 4c of the housing 4 of the tape printer 3 is covered with the photo stand 2. When the photo stand 2 is attached to the tape printer 3, the engaging protrusions 23, 24 provided to the left side frame portion 7c and the engaging protrusions 21, 22 provided to the right side frame portion 7d warp outward (toward the side of the outer surface of the printer 3). The engaging protrusions 23 and 24 are engaged with the engagement grooves 12 and 13, respectively, and the engaging protrusion 21 and 22 are engaged with the engagement groove 11. Thus, the photo stand 2 is tightly fixed to the tape printer 3 so that the photo stand 2 does not come off the tape printer 3 after the attachment. The engaging protrusions 21 to 24 are engaged with the predetermined respective engagement grooves 11 to 13. However, the order in which the engaging protrusions 21 to 24 are engaged with the respective engagement grooves 11 to 13 is not limited to the order described above. Any engaging protrusions 21 to 24 can be engaged first with the respective engagement grooves 11 to 13.

As shown in FIG. 10, in the state described above, the bottom portion 8 of the photo stand 2 and the feet 63, 64 (not shown in FIG. 10) provided on the lower surface 4b of the tape printer 3 contact the installed plane 75, and the tape printer 3 is inclined rightward with respect to the installed plane 75. Accordingly, the photograph 20 is held while oriented toward a direction that the picture side of the photograph 20 can be easily seen. The protrusion 6 provided to the lower surface 5b of the cover 5 prevents the tape printer 3 from falling, by contacting the installed plane 75, even when a force is applied to the tape printer 3 rightward in FIG. 10.

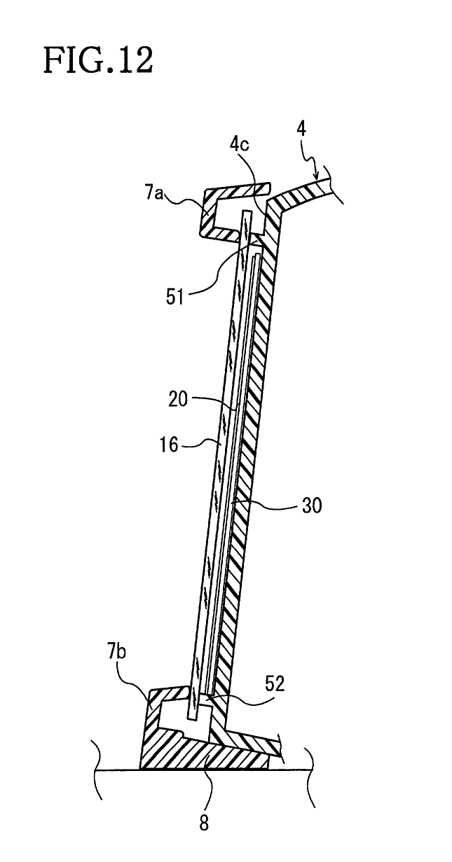

As shown in FIG. 12, the photograph 20 is prevented from being vertically displaced by the protrusions 51, 52 provided to the left side surface 4c of the tape printer 3. The protrusions 51, 52 regulates the vertical movement of the photograph 20. The other protrusions 53, 54 also provided to the left side surface 4c function as the same as the protrusions 51, 52. Consequently, the photograph 20 is prevented from being vertically displaced.

As described above, according to the printer with the photo stand 1 of the embodiment, the tape printer 3 is attached with the photo stand 2 to form a single unit. Accordingly, space can be saved as compared with a case where the tape printer 3 and the photo stand 2 are separately located on a desk, for example. The bottom portion is formed such that the projected portion 8c inclinatorily projects toward the upper frame portion 7a from the lower surface 8b, forming an acute angle with the lower surface 8b. Accordingly, the photograph 20 is held in an inclined posture in the photo stand 2, so that the photograph 20 is oriented toward a direction that the photograph 20 can be easily seen. The protrusion 6 provided to the lower surface 5b of the cover 5 prevents the tape printer 3 from falling toward an inclined direction even when the tape printer 3 is inclined with respect to the installed plane 75. The protrusions 51 to 54 provided on the left side surface 4c of the tape printer 3 prevent the photograph 20 from being vertically displaced.

The photo stand 2 is removed from the tape printer 3 as described below. The engaging protrusions 23, 24 engaged with the engagement grooves 12, 13, respectively, provided to the rear surface 4e of the tape printer 3, are disengaged therefrom. Then, the engaging protrusions 21, 22 engaged with the engagement groove 11 provided to the front surface 4d of the tape printer 3, are released therefrom. Thus, the photo stand 2 is removed from the tape printer 3. At that time, the engaging protrusions 21 to 24 warp outward and are disengaged from the respective engagement grooves 11 to 13. Any engaging protrusions 21 to 24 can be released first from the respective engagement grooves 11 to 13.

Although the invention has been described in detail with reference to a specific embodiment thereof, it would be apparent to those skilled in the art that various changes and modifications may be made therein without departing from the spirit of the invention. In the embodiment, the photograph 20 is supported from its rear by the cardboard 30 and is prevented from being vertically displaced by the protrusions 51 to 54 provided on the left side surface 4c of the housing 4 of the tape printer 3. However, in order to reduce a parts count, for example, the photograph 20 may be held from its rear by the only protrusions 51 to 54. Engagement mechanisms for attaching the photo stand 2 to the tape printer 3 can have symmetric shape and can be provided at symmetric positions. In the embodiment, the tape printer 3 is used as an example. However, an object to be attached with the photo stand is not limited to the tape printer, but various kinds of printers can be attached with the photo stand.

The outer surfaces of the tape printer 3 are formed with the engagement grooves 11 to 13. The photo stand 2 is attached to the tape printer 3 via the engagement grooves 11 to 13. The photo stand 2 includes the frame 7 in which the middle portion is open, the engaging protrusions 21 to 24 that are provided on the rear surface of the frame 7 and engage the respective engagement grooves 11 to 13 formed in the tape printer 3, the transparent panel 16 that covers the surface of the photograph 20 so as to be able to be seen therethrough, the cardboard 30 that holds the photograph 20 with the transparent panel 16 from the rear side of the frame 7, and the photo holding portion that is integrally formed to the base portion of each engagement protrusion 21 to 24 and urges the photograph 20 by contacting the cardboard 30.

In the printer with the photo stand 1 structured as described above, the engagement grooves 11 to 13 are formed in the outer surfaces of the tape printer 3. The engaging protrusions 21 to 24 formed to the rear side of the frame 7 of the photo stand 2 are engaged with the respective engagement grooves 11 to 13. Accordingly, the photo stand 2 is attached to the predetermined surface while oriented in a predetermined direction. Consequently, the photo stand 2 can be prevented from being attached to an improper surface of the tape printer 3 and from being attached to the tape printer 3 in an improper orientation.

In the printer with the photo stand 1 of the embodiment of the invention, the cardboard 30 has the cutaway portion 30a that is formed by cutting away from one side so as to be opened with a substantially U-shape. The cardboard 30 is formed with the cutaway portion 30a from the one side. The cardboard 30 holds the photograph 20 with the transparent panel 16 that covers the surface of the photograph 20 so that the photograph 20 can be seen through the transparent panel 16. Accordingly, the photograph 20 can be easily removed from the photo stand 2 by inserting a finger into the cutaway portion 30a.

The frame 7 is provided with the bottom portion 8 that extends in a direction smaller than a right angle by a predetermined angle with respect to the frame 7. The tape printer 3 is inclined at the predetermined angle with respect to a direction perpendicular to the installed plane 75 of the tape printer 3 when the tape printer 3 is attached with the photo stand 2 having the bottom portion 8. Accordingly, the photograph 20, or the like, inserted in the photo stand 2 is held in a posture that it can be easily seen.

In the printer with the photo stand 1, the left side surface 4c (FIGS. 2 and 12) to which the photo stand 2 is to be attached is provided with the protrusions 51, 53 at its upper positions and the protrusions 52, 54 at lower positions. With this structure, the photograph 20 held in the photo stand 2 can be prevented from being vertically displaced.

The lower surface 5b of the cover 5 is provided with the protrusion 6 that prevents the tape printer 3 inclined at the predetermined angle from falling in a direction of the installed plane 75. Therefore, the tape printer 3 inclined at the predetermined angle can be prevented from falling.

The engagement grooves 11 to 13 may be formed in asymmetric positions. The photo stand 2 is detachably attachable to the tape printer 3 via the engagement grooves 11 to 13 formed at the outer surfaces of the tape printer 3. The photo stand 2 includes the frame 7 in which the middle portion is open, the engaging protrusions 21 to 24 that are provided on the rear surface of the frame 7 and engage the respective engagement grooves 11 to 13 formed in the tape printer 3, the transparent panel 16 that covers the surface of the photograph 20 so as to be able to be seen therethrough, the cardboard 30 that holds the photograph 20 with the transparent panel 16 from the rear side of the frame 7, and the photo holding portion that is integrally formed to the base portion of each engagement protrusion 21 to 24 and urges the photograph 20 by contacting the cardboard 30.

The engagement grooves 11 to 13 are formed in the outer surfaces of the tape printer 3. The engaging protrusions 21 to 24 are formed to the rear side of the frame 7 of the photo stand 2. The engaging protrusions 21 to 24 of the frame 7 are engaged with the respective engagement grooves 11 to 13 formed in the tape printer 3. Accordingly, the photo stand 2 is attached to the predetermined surface while oriented in a predetermined direction. Consequently, the photo stand 2 can be prevented from being attached to an improper surface of the tape printer 3 and from being attached to the tape printer 3 in an improper orientation.

In the photo stand 2 of the embodiment of the invention, the cardboard 30 has the cutaway portion 30a that is formed by cutting away from one side so as to be opened with a substantially U-shape. The cardboard 30 is formed with the cutaway portion 30a from the one side. The cardboard 30 holds the photograph 20 with the transparent panel 16 that covers the surface of the photograph 20 so that the photograph 20 can be seen through the transparent panel 16. Accordingly, the photograph 20 can be easily removed from the photo stand 2 by inserting a finger into the cutaway portion 30a.

In the photo stand 2, the frame 7 is provided with the bottom portion 8 that extends in a direction smaller than a right angle by a predetermined angle with respect to the frame. Accordingly, the photograph 20 or the like inserted in the photo stand 2 is held in a posture so that it can be easily seen.

What is claimed is:

1. A printer with a photo stand that prints indicia on a recording medium, comprising:
a printer having an outer surface;
a plurality of engagement portions formed in the outer surface of the printer; and
a photo stand that is detachably attached to the engagement portions.

2. The printer with the photo stand according to claim 1, wherein the photo stand includes:
a frame in which a middle portion is open;
a plurality of engaging protrusions that are provided on a rear surface of the frame and engage the respective engagement portions formed in the printer; and
a photograph holding portion that is integrally formed to a base portion of each engagement protrusion and urges the photograph by contacting the rear panel.

3. The printer with the photo stand according to claim 12, wherein the rear panel includes a cutaway portion that is formed by cutting away from one side so as to be opened with a substantially U-shape.

4. The printer with the photo stand according to claim 1, wherein the frame is provided with a bottom portion that extends in a direction smaller than a right angle by a predetermined angle with respect to the frame, and the printer is inclined at the predetermined angle with respect to a direction perpendicular to an installed plane of the printer when the printer is attached with the photo stand having the bottom portion.

5. The printer with the photo stand according to claim 1, wherein the surface of the printer to which the photo stand is to be attached is provided with protrusions at its upper and lower portions.

6. The printer with the photo stand according to claim 4, wherein a bottom of the printer is provided with a protrusion that prevents the printer inclined at the predetermined angle from falling in a direction of the installed plane.

7. The printer with the photo stand according to claim 1, wherein the engagement portions are formed in asymmetric positions at a periphery of the printer.

8. A photo stand detachably attachable to a printer via a plurality of engagement portions formed in an outer surface of the printer, comprising:
a frame in which a middle portion is open;
a plurality of engaging protrusions that are provided on a rear surface of the frame and engage the respective engagement portions formed in the printer; and
a photograph holding portion that is integrally formed to a base portion of each engagement protrusion and urges the photograph by contacting the rear panel.

9. The photo stand according to claim 14, wherein the rear panel includes a cutaway portion that is formed by cutting away from one side so as to be opened with a substantially U-shape.

10. The photo stand according to claim 8, wherein the frame is provided with a bottom portion that extends in a direction smaller than a right angle by a predetermined angle with respect to the frame.

11. The printer with the photo stand according to claim 1, wherein the photo stand includes:
a frame in which a middle portion is open;
a plurality of engaging protrusions that are provided on a rear surface of the frame and engage the respective engagement portions formed in the printer;
a transparent panel that covers a surface of the photograph so as to be able to be seen therethrough; and
a photograph holding portion that is integrally formed to a base portion of each engagement protrusion and urges the photograph by contacting the rear panel.

12. The printer with the photo stand according to claim 1, wherein the photo stand includes:
a frame in which a middle portion is open;
a plurality of engaging protrusions that are provided on a rear surface of the frame and engage the respective engagement portions formed in the printer;
a transparent panel that covers a surface of the photograph so as to be able to be seen therethrough;
a rear panel that holds the photograph with the transparent panel from the rear side of the frame; and
a photograph holding portion that is integrally formed to a base portion of each engagement protrusion and urges the photograph by contacting the rear panel.

13. The photo stand according to claim 8, further comprising:
a transparent panel that covers a surface of the photograph so as to be able to be seen therethrough.

14. The photo stand according to claim 8, further comprising:
a rear panel that holds the photograph from the rear side of the frame.

15. The printer with the photo stand according to claim 1, wherein the engagement portions are formed in symmetric positions at a periphery of the printer.

16. The photo stand according to claim 8, wherein the frame is provided with a bottom portion having a plurality of recessed portions formed in an upper surface of the bottom portion to receive feet of the printer when the photo stand is attached to the printer.

17. The printer with the photo stand according to claim 2, wherein the frame of the photo stand is provided with a bottom portion having a plurality of recessed portions formed in an upper surface of the bottom portion to receive feet of the printer.

18. The printer with the photo stand according to claim 5, wherein the protrusions are equally positioned at four comers of the surface of the printer to which the photo stand is to be attached.

19. The photo stand according to claim 8, wherein the frame has convexly curved surface portions.

20. The photo stand according to claim 13, further comprising:
a rear panel that holds the photograph with the transparent panel from the rear side of the frame.
